(19) United States
(12) Patent Application Publication
(10) Pub. No.: US 2026/0204821 A1
(43) Pub. Date: Jul. 16, 2026

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Makoto MASHITA, Mie (JP); Takuya IWAMOTO, Mie (JP); Masakatsu MORIGUCHI, Mie (JP)

(21) Appl. No.: 19/134,744

(22) PCT Filed: Nov. 15, 2023
(86) PCT No.: PCT/JP2023/041012

§ 371 Date: Jun. 2, 2025

(30) Foreign Application Priority Data
Dec. 6, 2022 (JP) 2022-194603

(51) Int. Cl. H01R 12/72; H01R 12/73; H01R 13/512; H01R 13/516; H01R 13/60; H01R 13/6581; H01R 13/66

(52) U.S. Cl. CPC H01R 12/722; H01R 12/732; H01R 13/512; H01R 13/516; H01R 13/60; H01R 13/6581; H01R 13/6658

(57) ABSTRACT

The present invention achieves a reduction in height. This connector device comprises a circuit board (21) and a board connector (30) that is mounted to the circuit board (21). The board connector (30) includes a connector portion (31) disposed to protrude forward from a front edge (21F) of the circuit board (21), and a board mounting portion (60) which is mounted to overlap a mounting surface (22) of the circuit board (21). In a thickness direction of the circuit board (21), the circuit board (21) and the board mount portion (60) are disposed to be entirely within a height range of the connector portion (31).

### TECHNICAL FIELD

The present disclosure relates to a connector device.

### BACKGROUND

Patent Document 1 discloses a structure for mounting a circuit board connector on a circuit board. The circuit board connector is provided with a housing and a plurality of terminals mounted in the housing. The housing is fixed to the upper surface of the circuit board. Leg portions of the terminals are connected to the circuit board while being passed through through-holes of the circuit board.

### PRIOR ART DOCUMENT

### Patent Document

Patent Document 1: JP 2022-039257 A

### SUMMARY OF THE INVENTION

### Problems to be Solved

Since the housing is arranged to overlap the upper surface of the circuit board in the above structure, a dimension in a height direction of an entire device obtained by combining the circuit board and a circuit board harness is large.

A connector device of the present disclosure was completed on the basis of the above situation and aims to reduce a height.

### Means to Solve the Problem

The present disclosure is directed to a connector device with a circuit board and a board connector to be mounted on the circuit board, the board connector including a connector portion to be arranged to project forward from a front end edge of the circuit board and a board mounting portion to be mounted to overlap a mounting surface of the circuit board, and the circuit board and the entire board mounting portion being arranged to be accommodated within a height range of the connector portion in a plate thickness direction of the circuit board.

### Effect of the Invention

According to the present disclosure, a height can be reduced.

### BRIEF DESCRIPTION OF THE DRAWINGS

FIG. 1 is a perspective view of a connector device of one embodiment.

FIG. 2 is a perspective view of a housing and a circuit board in a disassembled state.

FIG. 3 is a perspective view of a board connector when viewed obliquely from an upper front side.

FIG. 4 is a perspective view of the board connector with an upper cover removed when viewed obliquely from an upper rear side.

FIG. 5 is a perspective view of the board connector in a disassembled state.

FIG. 6 is a perspective view of an outer conductor when viewed obliquely from the upper rear side.

FIG. 7 is a perspective view showing a state where inner conductors are mounted in a dielectric when viewed obliquely from the upper rear side.

FIG. 8 is a perspective view of a lower case when viewed obliquely from the upper front side.

FIG. 9 is a perspective view of the lower case when viewed obliquely from the upper rear side.

FIG. 10 is a side view in section showing a state before the board connector is mounted into the housing.

FIG. 11 is a bottom view in section showing the state before the board connector is mounted into the housing.

FIG. 12 is a side view in section showing a state where the board connector is mounted in the housing.

FIG. 13 is a bottom view in section showing the state where the board connector is mounted in the housing.

### DETAILED DESCRIPTION TO EXECUTE THE INVENTION

### Description of Embodiments of Present Disclosure

First, embodiments of the present disclosure are listed and described. Forms for carrying out the present invention also include arbitrary combinations of the following plurality of embodiments within a range not causing any contradiction.

(1) The connector device of the present disclosure is provided with a circuit board and a board connector to be mounted on the circuit board. The board connector includes a connector portion to be arranged to project forward from a front end edge of the circuit board and a board mounting portion to be mounted to overlap a mounting surface of the circuit board. The circuit board and the entire board mounting portion are arranged to be accommodated within a height range of the connector portion in a plate thickness direction of the circuit board. With the board connector mounted on the circuit board, the circuit board and the entire board mounting portion are accommodated within the height range of the connector portion. The connector device of the present disclosure can be reduced in height as compared to the case where the board connector is mounted in a state placed on the mounting surface of the circuit board.

(2) Preferably, the connector portion includes a terminal fitting, a terminal holding member for holding the terminal and a first sub-board mounted on the terminal fitting. The board mounting portion preferably includes a second sub-board to be arranged in parallel to the mounting surface. According to this configuration, since the second sub-board constituting the board mounting portion is arranged in parallel to the mounting surface, the entire board mounting portion can be reliably accommodated within the height range of the connector portion.

(3) Preferably, the first sub-board is arranged behind the terminal holding member, and the second sub-board is arranged behind the first sub-board. The first sub-board and the second sub-board are preferably connected via a flexible cable. According to this configuration, since the first and second sub-boards are connected by the flexible cable, a degree of design freedom is high in setting relative positions of the connector portion and the board mounting portion in a height direction.

(4) Preferably, a housing is provided which accommodates the circuit board and the board mounting portion. The connector portion preferably includes a dielectric, an inner conductor held by the dielectric and an outer conductor made of metal and mounted on the dielectric to surround the inner conductor. A front cover of the housing is preferably formed with an opening for exposing the connector portion to outside of the housing. The outer conductor is preferably fixed to the front cover by screwing. According to this configuration, the connector portion can be stably fixed to the housing.

(5) Preferably, the connector portion includes a dielectric, an inner conductor held by the dielectric and an outer conductor mounted on the dielectric to surround the inner conductor. The board mounting portion preferably includes a second sub-board to be arranged in parallel to the mounting surface and a lower case in the form of a flat plate for supporting the second sub-board placed thereon. The lower case is preferably assemblable with the outer conductor in a state where the board connector is not mounted on the circuit board. According to this configuration, the second sub-board can be kept in a stable positional relationship with the connector portion in the state where the board connector is not mounted on the circuit board.

(6) Preferably, the outer conductor and the lower case are made of metal. According to this configuration, since the outer conductor and the lower case are made of metal, the outer conductor and the lower case can be reliably assembled.

(7) Preferably, an upper cover is provided which is made of metal and assembled with the lower case to sandwich the second sub-board. According to this configuration, a shield shell for surrounding the second sub-board can be configured by the outer conductor, the lower case and the upper cover.

(8) Preferably, the outer conductor includes an arm portion extending rearward while being spaced apart from and facing a lower surface of the lower case. The circuit board is preferably arranged to be sandwiched between the lower case and the arm portion. According to this configuration, a positional relationship of the circuit board and the connector portion can be stabilized.

(9) Preferably, the first sub-board is perpendicular to the mounting surface and arranged to overlap a rear surface of the terminal holding member. According to this configuration, since the first sub-board is arranged to overlap the rear surface of the terminal holding member, a dimension of the connector portion in a front-rear direction can be suppressed to be small.

### Details of Embodiment of Present Disclosure

### Embodiment

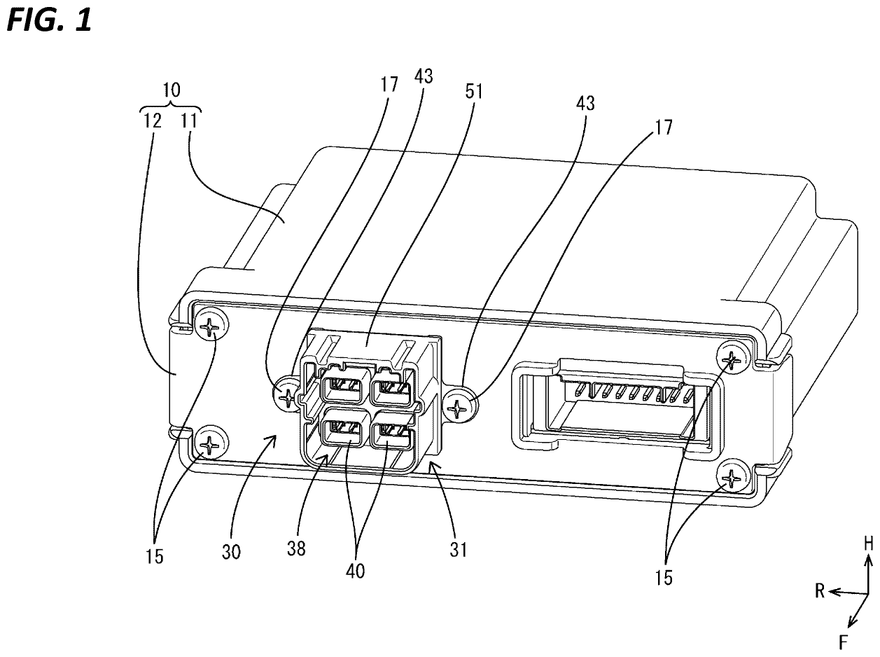

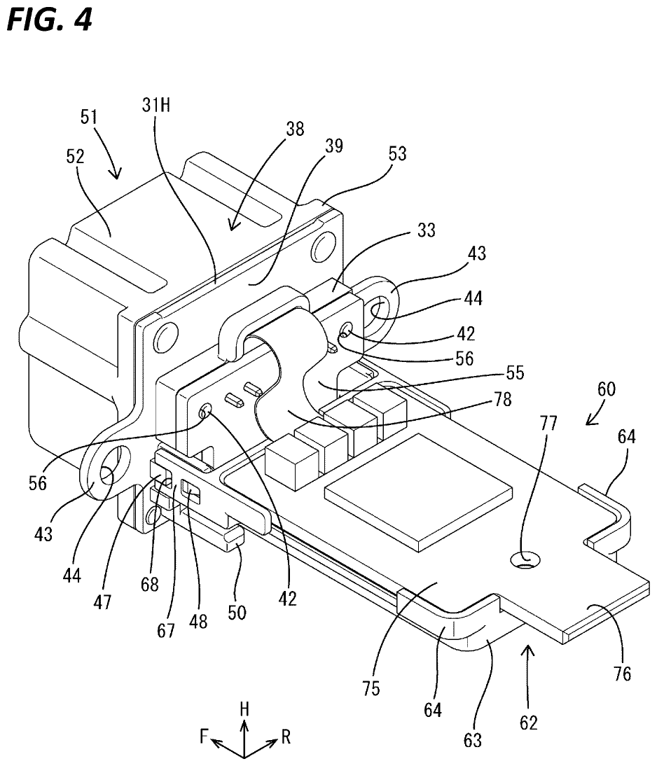

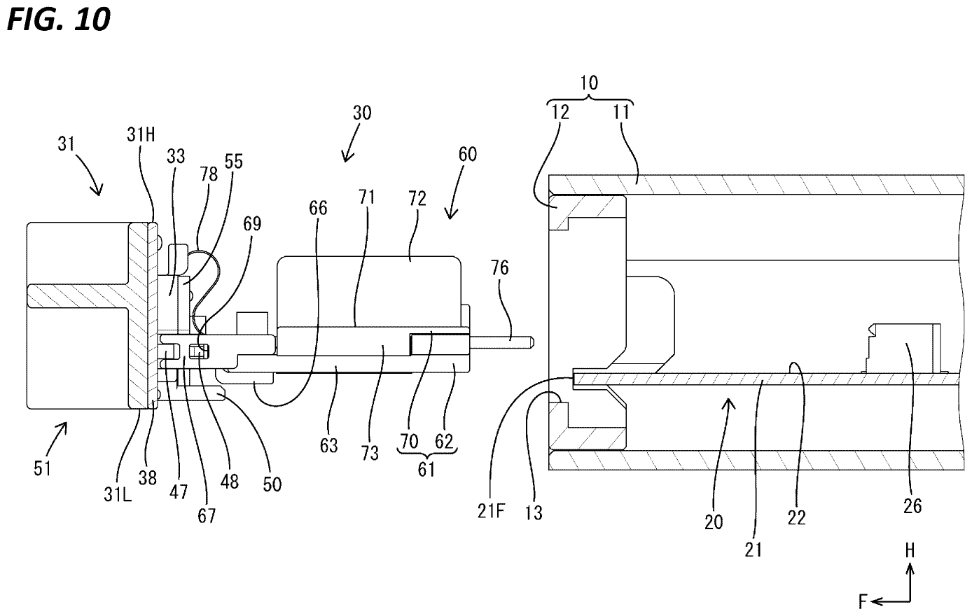

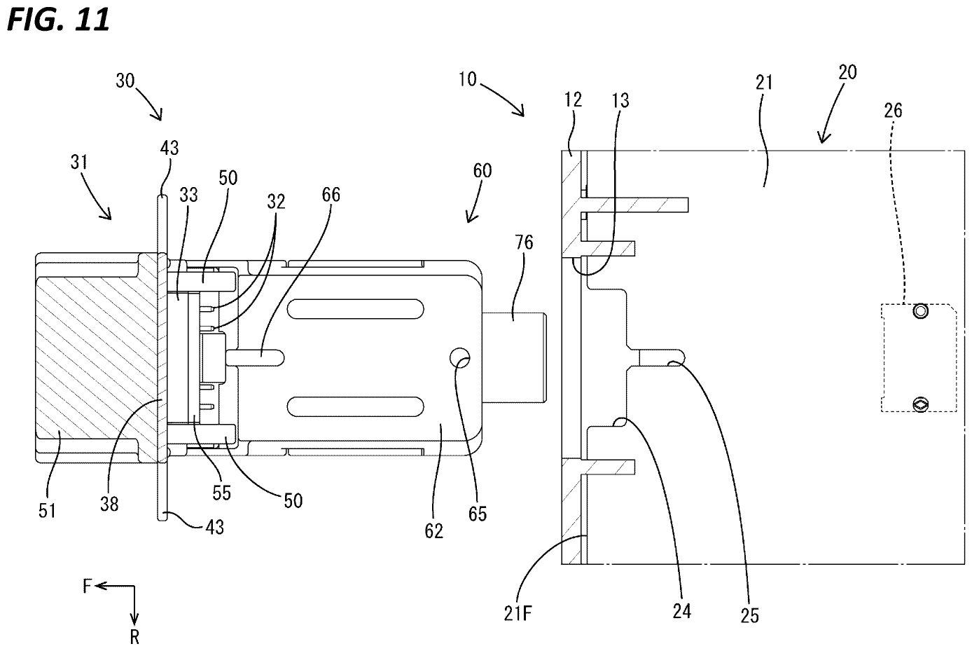

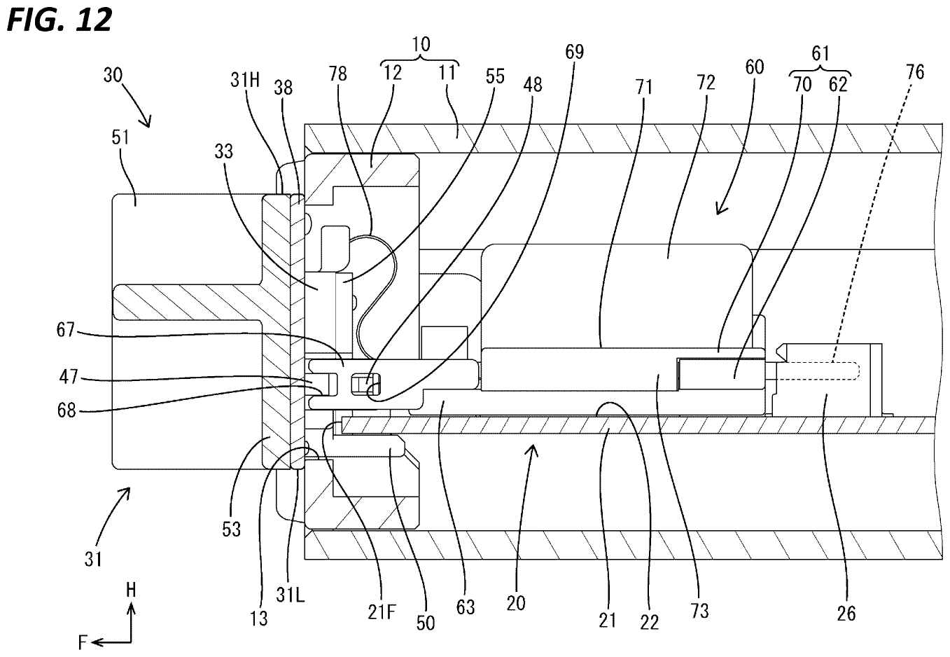

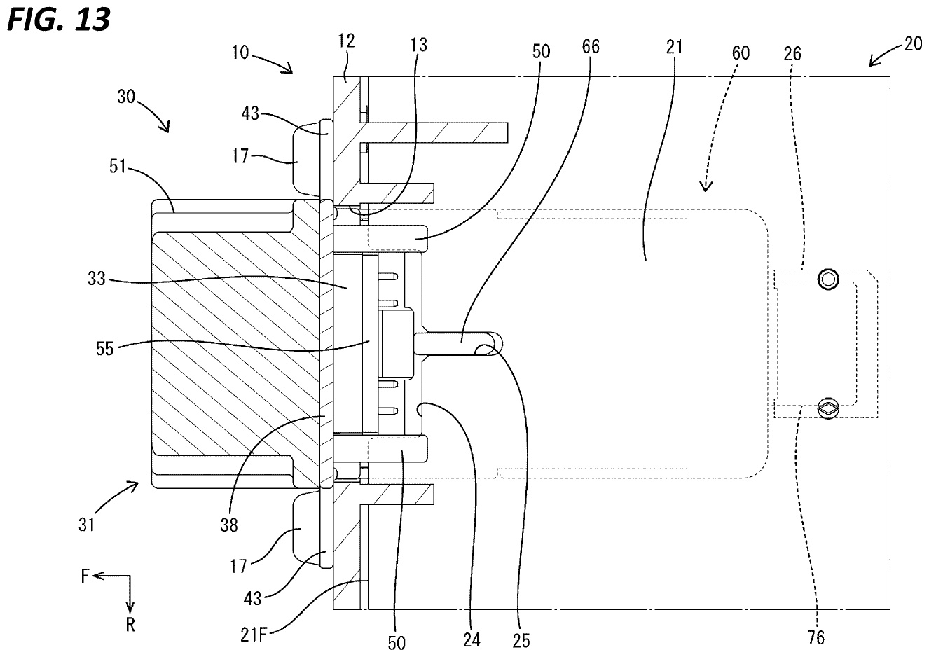

A connector device of one specific embodiment of the present disclosure is described with reference to FIGS. 1 to 13. The present invention is not limited to these illustrations, but is represented by claims and intended to include all changes in the scope of claims and in the meaning and scope of equivalents. In this embodiment, a direction F in FIGS. 1 to 13 is defined as a forward direction concerning a front-rear direction. A direction R in FIGS. 1 to 9, 11 and 13 is defined as a rightward direction concerning a lateral direction. A direction Hin FIGS. 1 to 10 and 12 is defined as an upward direction concerning a vertical direction.

The connector device of this embodiment is, for example, a device installed in an automotive vehicle and constituting an in-vehicle communication circuit for automatic driving control by the Ethernet (registered trademark). The connector device is configured by assembling a housing 10, a board unit 20 and a board connector 30. The board connector 30 has a function as a relay connector for relaying between various in-vehicle devices and the board unit 20.

### (Housing 10)

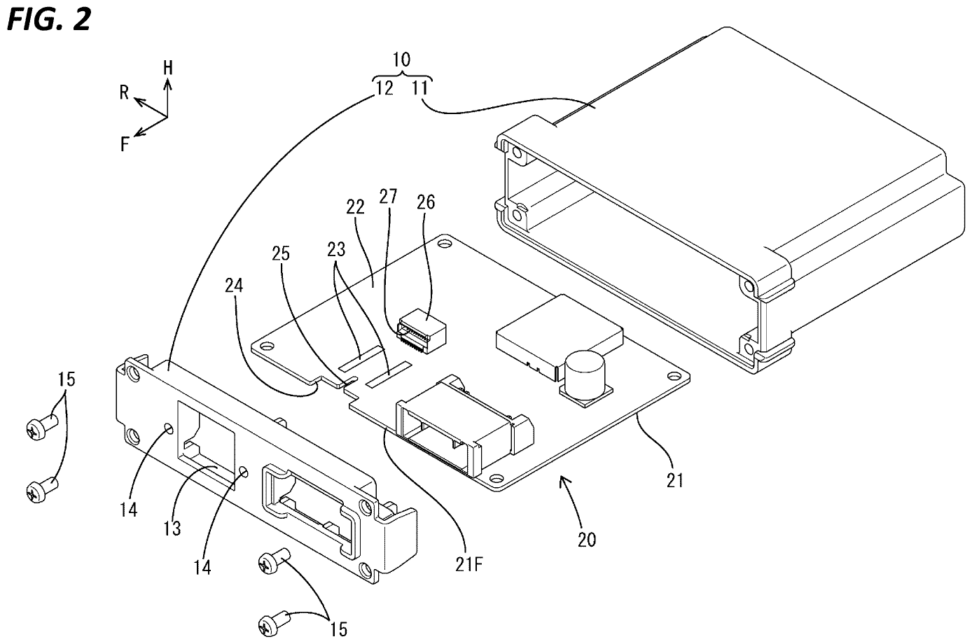

As shown in FIGS. 1 and 2, the housing 10 is configured by assembling a box-shaped housing body 11 having an open front surface and a front cover 12 for closing an opening in the front surface of the housing body 11. The front cover 12 is formed with an opening 13 for exposing the board connector 30 to the outside of the housing 10. A pair of internally threaded portions 14 are formed at positions of the front cover 12 on left and right sides of the opening 13. The front cover 12 is assembled with and held on the housing body 11 by screws 15. The entire board unit 20 and a part (rear end part) of the board connector 30 are accommodated in the housing 10.

(board Unit 20)

As shown in FIGS. 2 and 10 to 13, the board unit 20 is provided with a circuit board 21 and a mounted connector 26. In this embodiment, the structure is described, assuming that the circuit board 21 is fixed in a horizontal posture in the housing body 11 for the sake of convenience. The upper surface of the circuit board 21 functions as a mounting surface 22. As shown in FIG. 2, the mounting surface 22 is formed with a pair of main ground circuits 23 extending in the front-rear direction. The pair of main ground circuits 23 are arranged at an interval in the lateral direction.

The circuit board 21 is formed with a cut portion 24 formed by cutting a front end edge 21F of the circuit board 21 into a rectangular shape. A formation range of the cut portion 24 in the front-rear direction is a region extending from the front end edge 21F of the circuit board 21 to a position in front of the front ends of the main ground circuits 23. In the lateral direction, both left and right side edges of the cut portion 24 are arranged at the same positions as the pair of main ground circuits 23. The circuit board 21 is formed with a guide groove 25. The guide groove 25 extends straight rearward from a lateral central part of the rear end edge of the cut portion 24.

As shown in FIG. 2, the mounted connector 26 is arranged between the pair of main ground circuits 23 in the lateral direction. The mounted connector 26 is arranged behind the rear ends of the main ground circuits 23. The mounted connector 26 includes a board accommodation space 27. The board accommodation space 27 is in the form of a slit elongated in the lateral direction and open in the front surface of the mounted connector 26. A plurality of connection terminals (not shown) facing the inside of the board accommodation space 27 are accommodated in the mounted connector 26. The board unit 20 is accommodated in the housing 10 and fixed at a predetermined position.

### (Board Connector 30)

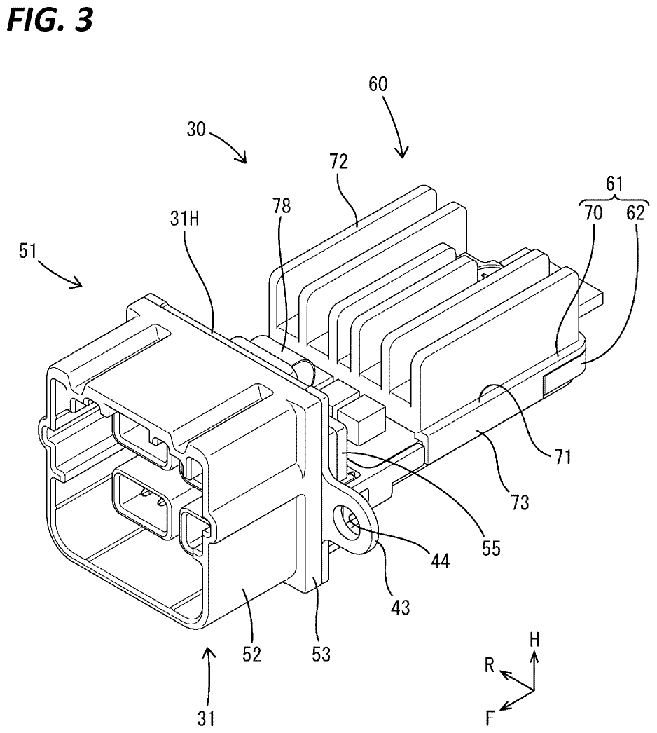

The board connector 30 is a connector having a shielding function and, as shown in FIG. 3, provided with a connector portion 31, a board mounting portion 60 and a flexible cable 78. The connector portion 31 and the board mounting portion 60 are connected via the flexible cable 78. The connector portion 31 is, for example, connected to a device-side ECU (Electronic Control Unit) of a communication device (not shown) used for automatic driving control via a wiring harness (not shown). Examples of an automatic driving control device include a LiDAR (Light Detection and Ranging) device and the like. The board mounting portion 60 is attachable to and detachable from the mounted connector 26.

### (Connector Portion 31)

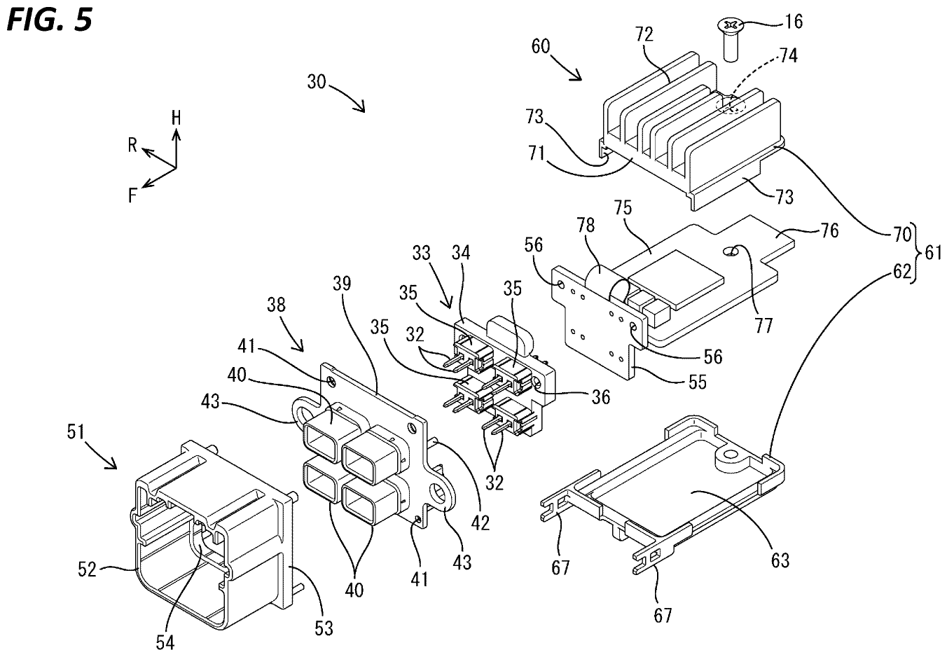

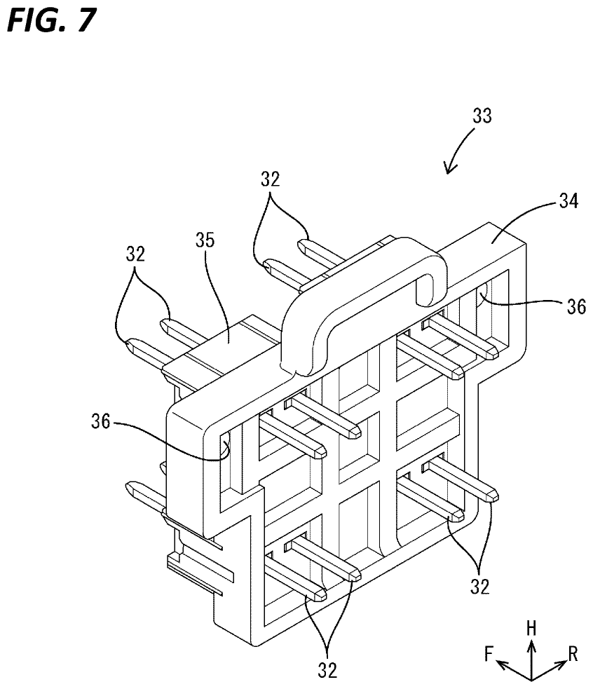

As shown in FIG. 5, the connector portion 31 is provided with four pairs of inner conductors 32, one dielectric 33, one outer conductor 38, one fitting member 51 and one first sub-board 55. Each inner conductor 32 is constituted by a metal component elongated in the front-rear direction. A pair of the inner conductors 32 constitute one differential pair circuit. As shown in FIG. 7, the dielectric 33 includes a wall-like portion 34 having a plate thickness direction oriented in the front-rear direction and four projection-like holding portions 35 projecting forward from the wall-like portion 34. A pair of through holes 36 are formed in both left and right end parts of the wall-like portion 34. The through holes 36 penetrate through the wall-like portion 34 in the front-rear direction. The pair of inner conductors 32 are held to penetrate through each projection-like holding portion 35 in the front-rear direction.

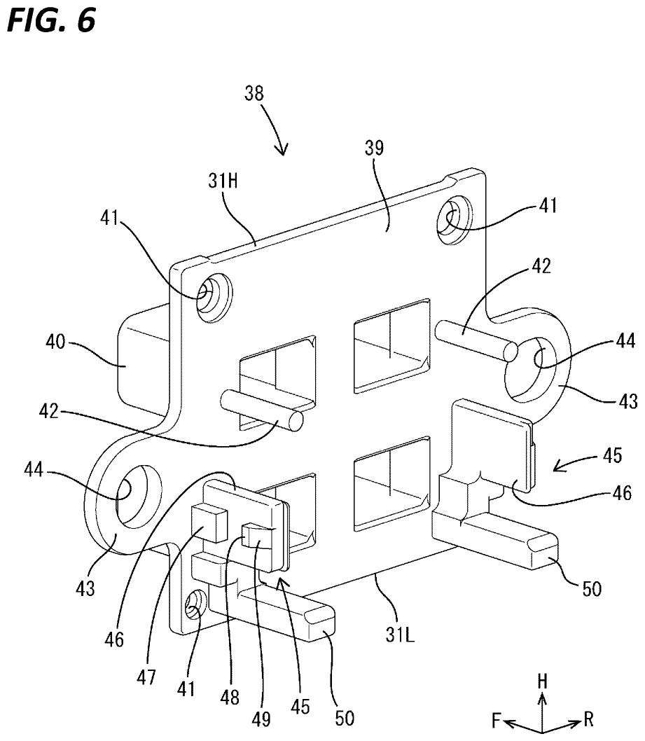

The outer conductor 38 is a single component made of a metal material. As shown in FIGS. 5 and 6, the outer conductor 38 includes a plate-like portion 39 having a plate thickness direction oriented in the front-rear direction and four tubular portions 40 projecting forward from the plate-like portion 39. In a front view of the outer conductor 38, the plate-like portion 39 has a rectangular or square shape. The upper end surface of the plate-like portion 39 is located on the uppermost end of the outer conductor 38 and arranged at an uppermost end 31H of the connector portion 31. The lower end surface of the plate-like portion 39 is located at the lowermost end of the outer conductor 38 and arranged at a lowermost end 31L of the connector portion 31.

The rear end of the tubular portion 40 is open in the rear surface of the plate-like portion 39. Four holding holes 41 penetrating through the plate-like portion 39 in the front-rear direction are formed on four corners of the plate-like portion 39. The outer conductor 38 is formed with a pair of bilaterally symmetrical positioning protrusions 42. The positioning protrusion 42 is in the form of an elongated cantilever extending rearward from the plate-like portion 39. The outer conductor 38 is formed with a pair of bilaterally symmetrical plate-like mounting portions 43. The plate-like mounting portions 43 have a plate thickness direction oriented in the front-rear direction and project laterally outward from both left and right side edges of the plate-like portion 39. The plate-like mounting portion 43 is formed with a mounting hole 44 penetrating through the plate-like mounting portion 43 in the front-rear direction.

The outer conductor 38 is formed with a pair of bilaterally symmetrical supporting portions 45 and a pair of bilaterally symmetrical arm portions 50. The pair of supporting portions 45 are cantilevered rearward from both left and right end parts of the plate-like portion 39. The supporting portion 45 includes a supporting wall portion 46 having a plate thickness direction oriented in the front-rear direction, a front projection 47 and a rear projection 48. The front projection 47 is arranged in a front end part of the outer side surface of the supporting wall portion 46. The rear projection 48 is arranged in a rear end part of the outer side surface of the supporting wall portion 46. The rear end part of the rear projection 48 is formed with a guide surface 49 inclined to reduce a projecting dimension from the supporting wall portion 46 toward a rear side.

The pair of arm portions 50 are in the form of cantilevers extending rearward from both left and right end parts of a lower end part of the plate-like portion 39. The arm portion 50 is arranged below the supporting portion 45. The lower surface of the arm portion 50 is located above the lower end surface of the plate-like portion 39. A supporting space having a dimension equal to or slightly smaller than a plate thickness of the circuit board 21 is ensured between the upper surfaces of the arm portions 50 and the lower surfaces of the supporting portions 45.

The fitting member 51 is a single component made of synthetic resin. As shown in FIGS. 3 and 5, the fitting member 51 includes a receptacle 52 in the form of a rectangular tube and a rear wall portion 53 for covering the rear surface of the receptacle 52. The rear wall portion 53 is formed with four communication holes 54. The upper surface of the fitting member 51 is arranged at the uppermost end 31H of the connector portion 31, similarly to the upper end surface of the plate-like portion 39 of the outer conductor 38. The lower surface of the fitting member 51 is arranged at the lowermost end 31L of the connector portion 31, similarly to the lower end surface of the plate-like portion 39 of the outer conductor 38.

The first sub-board 55 is arranged in a rear end part of the connector portion 31 with a plate thickness direction oriented in the front-rear direction. Electronic components are mounted on the rear surface of the first sub-board 55. A pair of positioning holes 56 are formed in upper end parts of both left and right end parts of the first sub-board 55. The positioning hole 56 penetrates through the first sub-board 55 in the front-rear direction.

By assembling the inner conductors 32, the dielectric 33, the outer conductor 38, the fitting member 51 and the first sub-board 55, the connector portion 31 is configured. The fitting member 51 is arranged on the foremost end of the connector portion 31, and the first sub-board 55 is arranged on the rearmost end of the connector portion 31. The outer conductor 38 is assembled with the fitting member 51 from behind. The front surface of the plate-like portion 39 of the outer conductor 38 is placed in surface contact with the rear surface of the rear wall portion 53 of the fitting member 51. The four tubular portions 40 are individually passed through the four communication holes 54. A pair of holding projections of the fitting member 51 are individually passed through a pair of the holding holes 41 of the outer conductor 38. Rear end parts of the holding projections are plastically deformed to be enlarged in diameter by being heated, and held in close contact with the rear surface of the plate-like portion 39. The outer conductor 38 and the fitting member 51 are held in an assembled state by locking the rear end parts of the holding projections to hole edge parts of the holding holes 41.

The dielectric 33 holding the inner conductors 32 are assembled with the outer conductor 38 from behind. The front surface of the wall-like portion 34 of the dielectric 33 is placed in surface contact with the rear surface of the plate-like portion 39 of the outer conductor 38. The four projection-like holding portions 35 are individually fit into the four tubular portions 40. The pair of positioning protrusions 42 of the outer conductor 38 are individually passed through the pair of through holes 36 of the dielectric 33.

The first sub-board 55 is assembled with the dielectric 33 from behind. The front surface of the first sub-board 55 is placed in surface contact with the rear surface of the wall-like portion 34 of the dielectric 33. Rear end parts of the inner conductors 32 are individually inserted through through-holes of the first sub-board 55, and the inner conductors 32 and the first sub-board 55 are conductively connected. Rear end parts of the pair of positioning protrusions 42 are individually press-fit into the pair of positioning holes 56 of the first sub-board 55. By press-fitting the positioning protrusions 42 into the positioning holes 56, the outer conductor 38, the dielectric 33 and the first sub-board 55 are held in an assembled state.

The dielectric 33 is located to be sandwiched between the plate-like portion 39 of the outer conductor 38 and the first sub-board 55. The plate-like portion 39 of the outer conductor 38, the wall-like portion 34 of the dielectric 33 and the first sub-board 55 are arranged in a state stacked in the front-rear direction. The uppermost end of the dielectric 33 and that of the first sub-board 55 are arranged at positions lower than the uppermost end 31H of the connector portion 31.

### (Board Mounting Portion 60)

The board mounting portion 60 is provided with one shield shell 61 and one second sub-board 75. As shown in FIG. 5, the shield shell 61 is provided with a lower case 62 and an upper cover 70. A flat shield space (not shown) having a height smaller than dimensions in the front-rear direction and the lateral direction is ensured inside the shield shell 61.

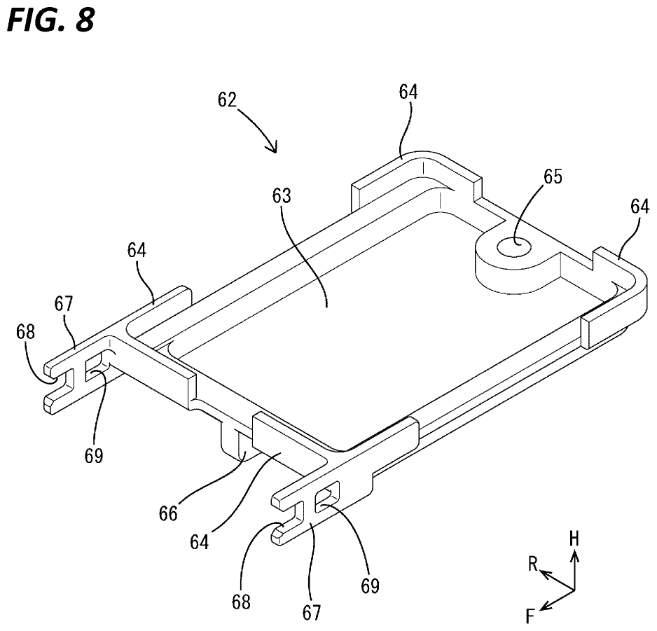

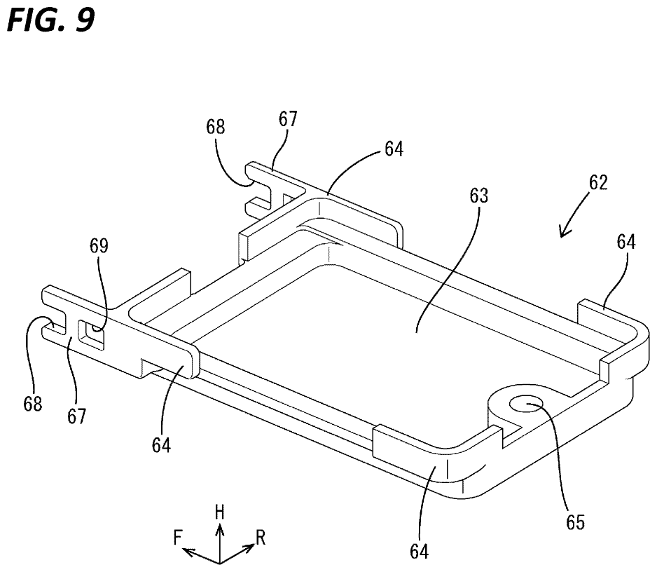

The lower case 62 is a single component made of the same type of metal material as the outer conductor 38. The lower case 62 is a single component in the form of a plate having a thickness direction oriented in the vertical direction as a whole. As shown in FIGS. 8 and 9, the lower case 62 includes a case body portion 63 having a rectangular shape in a plan view and a pair of bilaterally symmetrical coupling portions 67. The case body portion 63 is in the form of a rectangular plate having a shallowly recessed upper surface. Positioning portions 64 in the form of ribs L-shaped in a plan view and projecting upward are formed on four corners of the case body portion 63. An internally threaded hole 65 is formed in a rear end part of the case body portion 63. A guide rib 66 extending in the front-rear direction is formed in a front end part of the lower surface of the case body portion 63.

The pair of coupling portions 67 are in the shape of cantilevers projecting forward from both left and right end parts of the front end edge of the case body portion 63. The coupling portion 67 is in the form of a plate having a plate thickness direction oriented in the lateral direction. A rectangular coupling recess 68 is formed in a front end part of the coupling portion 67 by recessing the front end edge of the coupling portion 67. A rectangular coupling hole 69 penetrating in the lateral direction is formed in a rear end part of the coupling portion 67.

The upper cover 70 is a single component made of the same type of metal material as the outer conductor 38 and the lower case 62. The upper cover 70 includes a plate-like base portion 71 having a plate thickness direction oriented in the vertical direction, a heat sink 72 formed on the upper surface of the plate-like base portion 71 and positioning ribs 73 formed on both left and right side edge parts of the plate-like base portion 71. An insertion hole 74 penetrating through the plate-like base portion 71 in the vertical direction is formed in a rear end part of the plate-like base portion 71.

The second sub-board 75 is arranged in a horizontal posture with a plate thickness direction oriented in the vertical direction. A card edge connecting portion 76 to be inserted into the board accommodation space 27 of the mounted connector 26 is formed on a rear end edge part of the second sub-board 75. An insertion hole 77 vertically penetrating through the second sub-board 75 is formed at a position in front of the card edge connecting portion 76, out of a rear end side area of the second sub-board 75.

The first and second sub-boards 55, 75 are coupled by the flexible cable 78. Thus, the lower case 62 is first assembled with the outer conductor 38 prior to the assembly of the board mounting portion 60. In assembling, the lower case 62 is arranged behind the outer conductor 38, and the coupling portions 67 of the lower case 62 are brought closer to the supporting portions 45 of the outer conductor 38 from behind. In an assembly process, the pair of coupling portions 67 are resiliently expanded by the sliding contact of the coupling recesses 68 with the guide surfaces 49 of the rear projections 48.

If the coupling recesses 68 passes the rear projections 48, the pair of coupling portions 67 resiliently return and the lower case 62 and the outer conductor 38 reach a properly assembled state. In the properly assembled state, the coupling recesses 68 are fit to the front projections 47, the coupling holes 69 are fit to the rear projections 48, and the lower case 62 and the outer conductor 38 are held in the assembled state by the fitting of these. The lower case 62 projects rearward in a cantilever manner from the outer conductor 38.

After the lower case 62 is assembled with the outer conductor 38, the second sub-board 75 is placed on the case body portion 63 of the lower case 62. The second sub-board 75 is positioned in the front-rear direction and the lateral direction by the positioning portions 64. After the second sub-board 75 is mounted into the lower case 62, the upper cover 70 is assembled to be put on the second sub-board 75. The positioning ribs 73 are fit to both left and right side edge parts of the case body portion 63, whereby the upper cover 70 is positioned with respect to the lower case 62. In the above way, the lower case 62, the second sub-board 75 and the upper cover 70 are temporarily assembled in a vertically stacked state. Most (mounted components) of the second sub-board 75 is accommodated in the shield space.

In the temporarily assembled state, a screw 16 is inserted through the insertion hole 74 of the upper cover 70 and the insertion hole 77 of the second sub-board 75 and screwed and tightened into the internally threaded hole 65 of the lower case 62. In the above way, the lower case 62, the upper cover 70 and the second sub-board 55 are integrated, and the assembly of the board mounting portion 60 and the assembly of the board connector 30 are completed at the same time as the assembly of the shield shell 61 is completed.

The board mounting portion 60 extends horizontally rearward from the connector portion 31. The card edge connecting portion 76 projects further rearward than the rear end of the shield shell 61 (lower case 62 and upper cover 70). In the vertical direction, the entire board mounting portion 60 is arranged only within a range from the lowermost end 31L to the uppermost end 31H of the connector portion 31. The uppermost end of the board mounting portion 60 (upper surface of the upper cover 70) and the uppermost end of the flexible cable 78 are located below the uppermost end 31H of the connector portion 31. The lowermost end of the board mounting portion 60 (lower surface of the guide rib 66 of the lower case 62) is located above the lowermost end 31L of the connector portion 31.

(Assembly of Board Connector 30 with Housing 10 and Board Unit 20)

When the board connector 30 is mounted into the housing 10 and the board unit 20, the board connector 30 is inserted into the housing 10 through the opening 13 of the front cover 12. In an insertion process, the board connector 30 is positioned in the lateral direction with respect to the circuit board 21 by bringing the lower surface of the lower case 62 into sliding contact with the mounting surface 22 of the circuit board 21 and fitting a lower end part of the dielectric 33 and a lower end part of the first sub-board 55 into the cut portion 24 of the circuit board 21. If the board connector 30 is inserted from this state, the guide rib 66 is fit into the guide groove 25, whereby the orientation of the board connector 30 in the lateral direction is stabilized.

If the card edge connecting portion 76 is inserted into the board accommodation space 27 of the mounted connector 26 and the plate-like portion 39 of the outer conductor 38 and the plate-like mounting portion 43 come into contact with the front surface of the front cover 12, the insertion of the board connector 30 is finished. Thereafter, screws 17 are inserted through the mounting holes 44 of the outer conductor 38 and screwed and tightened into the internally threaded portions 14 of the front cover 12. In the above way, the assembly of the board connector 30 with the housing 10, the mounting of the board connector 30 into the board unit 20 and the connection of the mounted connector 26 and the board connector 30 are completed.

With the board connector 30 assembled with the circuit board 21, a front end part of the circuit board 21 is sandwiched between the upper surfaces of the arm portions 50 of the outer conductor 38 and the lower surface of the lower case 62. Thus, the positional relationship and posture of the board connector 30 with respect to the circuit board 21 in the vertical direction are stabilized. In a height direction, which is a plate thickness direction of the circuit board 21, the position of the uppermost end of the board connector 30 is at the same height as the uppermost end 31H of the connector portion 31 and the position of the lowermost end of the board connector 30 is at the same height as the lowermost end 31H of the connector portion 31. In the height direction, the entire board mounting portion 60 and the entire board unit 20 are arranged only within the range between the uppermost end 31H and the lowermost end 31L of the connector portion 31. Thus, the connector device of this embodiment is reduced in height as compared to the case where the board mounting portion 60 and the board unit 20 are located at a height below the lowermost end 31L of the connector portion 31.

### Functions and Effects of Embodiment

The connector device of this embodiment is provided with the circuit board 21 and the board connector 30 to be mounted on the circuit board 21. The board connector 30 includes the connector portion 31 and the board mounting portion 60. The connector portion 31 is arranged to project forward from the front end edge 21F of the circuit board 21. The board mounting portion 60 is mounted to overlap the mounting surface 22 (upper surface) of the circuit board 21 in the height direction. With the board connector 30 mounted on the circuit board 21, the circuit board 21 and the entire board mounting portion 60 are arranged to be accommodated within a height range of the connector portion 31 in the plate thickness direction of the circuit board 21. The connector device of this embodiment can be reduced in height as compared to the case where the board connector 30 is mounted in a state placed on the mounting surface 22 of the circuit board 21.

The connector portion 31 includes the inner conductors 32 serving as terminal fittings, the dielectric 33 serving as a terminal holding member for holding the inner conductors 32 and the first sub-board 55 mounted on the inner conductors 32. The board mounting portion 60 includes the second sub-board 75 arranged in parallel to the mounting surface 22. Since the second sub-board 75 constituting the board mounting portion 60 is arranged in parallel to the mounting surface 22, the entire board mounting portion 60 can be reliably accommodated within the height range of the connector portion 31.

The first sub-board 55 is arranged behind the dielectric 33 (terminal holding member). The second sub-board 75 is arranged behind the first sub-board 55. Since the first and second sub-boards 55, 75 are connected via the flexible cable 78, a degree of design freedom is high in setting relative positions of the connector portion 31 and the board mounting portion 60 in the height direction.

The connector device of this embodiment is provided with the housing 10 for accommodating the circuit board 21 and the board mounting portion 60. The connector portion 31 includes the outer conductor 38 made of metal and mounted on the dielectric 33 to surround the inner conductors 32. The front cover 12 of the housing 10 is formed with the opening 13 for exposing the connector portion 31 to the outside of the housing 10. The outer conductor 38 is fixed to the front cover 12 by the screw 17 (screwing). By using the screw 17, the connector portion 31 can be stably fixed to the housing 10.

The board mounting portion 60 includes the second sub-board 75 arranged in parallel to the mounting surface 22 and the lower case 62 in the form of a flat plate for supporting the second sub-board 75 placed thereon. The lower case 62 can be assembled with the outer conductor 38 in a state where the board connector 30 is not mounted on the circuit board 21. In the state where the board connector 30 is not mounted on the circuit board 21, the second sub-board 75 can be held in a stable positional relationship with the connector portion 31. Since the outer conductor 38 and the lower case 62 are made of metal, the outer conductor 38 and the lower case 62 can be reliably assembled.

The connector device is provided with the upper cover 70 made of metal and to be assembled with the lower case 62 to sandwich the second sub-board 75. The shield shell 61 for surrounding the second sub-board 75 is constituted by the lower case 62 and the upper cover 70.

The outer conductor 38 includes the arm portions 50 extending rearward while being spaced apart from and facing the lower surface of the lower case 62. The circuit board 21 is arranged to be sandwiched between the lower case 62 and the arm portions 50. A positional relationship of the circuit board 21 and the connector portion 31 can be stabilized by sandwiching the circuit board 21 between the lower case 62 and the arm portions 50.

The first sub-board 55 is perpendicular to the mounting surface 22 and arranged to overlap the rear surface of the dielectric 33. According to this configuration, a dimension of the connector portion 31 in the front-rear direction can be suppressed to be small.

### Other Embodiments

The present invention is not limited to the above described and illustrated embodiment, but is represented by claims. The present invention includes all changes in the scope of claims and in the meaning and scope of equivalents and also includes the following embodiments.

A second sub-board may be arranged to be perpendicular to a mounting surface.

First and second sub-boards may be connected by a member other than a flexible cable.

The number of sub-boards provided in the board connector may be one, three or more.

The present invention can be applied also when a terminal holding member does not function as a dielectric and a connector portion does not include an outer conductor.

A lower case may be made of synthetic resin.

A board mounting portion may be configured not to include an upper cover.

A circuit board may not be sandwiched between a lower case and arm portions.

A first sub-board may be arranged in parallel to a mounting surface.

A first sub-board may be arranged at a position separated from a terminal holding member.

### LIST OF REFERENCE NUMERALS

10 . . . housing
11 . . . housing body
12 . . . front cover
13 . . . opening
14 . . . internally threaded portion
15 . . . screw
16 . . . screw
17 . . . screw
20 . . . board unit
21 . . . circuit board
21F . . . front end edge of circuit board
22 . . . mounting surface
23 . . . main ground circuit
24 . . . cut portion
25 . . . guide groove
26 . . . mounted connector
27 . . . board accommodation space
30 . . . board connector
31 . . . connector portion
31H . . . uppermost end of connector portion
31L . . . lowermost end of connector portion
32 . . . inner conductor (terminal fitting)
33 . . .dielectric (terminal holding member)
34 . . . wall-like portion
35 . . . projection-like holding portion
36 . . . through hole
38 . . . outer conductor
39 . . . plate-like portion
40 . . . tubular portion
41 . . . holding hole
42 . . . positioning protrusion
43 . . . plate-like mounting portion
44 . . . mounting hole
45 . . . supporting portion
46 . . . supporting wall portion
47 . . . front projection
48 . . . rear projection
49 . . . guide surface
50 . . . arm portion
51 . . . fitting member
52 . . . receptacle
53 . . . rear wall portion
54 . . . communication hole
55 . . . first sub-board
56 . . . positioning hole
60 . . . board mounting portion
61 . . . shield shell
62 . . . lower case
63 . . . case body portion
64. positioning portion
65 . . . internally threaded hole
66 . . . guide rib
67 . . . coupling portion
68 . . . coupling recess
69 . . . coupling hole
70 . . . upper cover
71 . . . plate-like base portion
72 . . . heat sink
73 . . . positioning rib
74 . . . insertion hole
75 . . . second sub-board
76 . . . card edge connecting portion
77 . . . insertion hole
78 . . . flexible cable

1. A connector device, comprising:
a circuit board; and
a board connector to be mounted on the circuit board,
the board connector including a connector portion to be arranged to project forward from a front end edge of the circuit board and a board mounting portion to be mounted to overlap a mounting surface of the circuit board, and
the circuit board and the entire board mounting portion being arranged to be accommodated within a height range of the connector portion in a plate thickness direction of the circuit board.

2. The connector device of claim 1, wherein:
the connector portion includes a terminal fitting, a terminal holding member for holding the terminal and a first sub-board mounted on the terminal fitting, and
the board mounting portion includes a second sub-board to be arranged in parallel to the mounting surface.

3. The connector device of claim 2, wherein:
the first sub-board is arranged behind the terminal holding member,
the second sub-board is arranged behind the first sub-board, and
the first sub-board and the second sub-board are connected via a flexible cable.

4. The connector device of claim 1, comprising a housing for accommodating the circuit board and the board mounting portion, wherein:
the connector portion includes a dielectric, an inner conductor held by the dielectric and an outer conductor made of metal and mounted on the dielectric to surround the inner conductor,
a front cover of the housing is formed with an opening for exposing the connector portion to outside of the housing, and
the outer conductor is fixed to the front cover by screwing.

5. The connector device of claim 1, wherein:
the connector portion includes a dielectric, an inner conductor held by the dielectric and an outer conductor mounted on the dielectric to surround the inner conductor,
the board mounting portion includes a second sub-board to be arranged in parallel to the mounting surface and a lower case in the form of a flat plate for supporting the second sub-board placed thereon, and
the lower case is assemblable with the outer conductor in a state where the board connector is not mounted on the circuit board.

6. The connector device of claim 5, wherein the outer conductor and the lower case are made of metal.

7. The connector device of claim 6, comprising an upper cover made of metal, the upper cover being assembled with the lower case to sandwich the second sub-board.

8. The connector device of claim 5, wherein:
the outer conductor includes an arm portion extending rearward while being spaced apart from and facing a lower surface of the lower case, and
the circuit board is arranged to be sandwiched between the lower case and the arm portion.

9. The connector device of claim 2, wherein the first sub-board is perpendicular to the mounting surface and arranged to overlap a rear surface of the terminal holding member.
